(19) United States
(12) Patent Application Publication
(10) Pub. No.: US 2009/0164680 A1
(43) Pub. Date: Jun. 25, 2009

(54) ACCESS, MONITORING AND COMMUNICATION DEVICE AND METHOD

(76) Inventors: Anatoli Stobbe, Barsinghausen (DE); Thomas Gries, Barsinghausen (DE)

Correspondence Address: THOMPSON & THOMPSON, P.A., P.O BOX 166, SCANDIA, KS, 66966, US

(21) Appl. No.: 11/960,914

(22) Filed: Dec. 20, 2007

(51) Int. Cl. G06F 13/18

(52) U.S. Cl. 710/110

(57) ABSTRACT

An access, monitoring and communication device and method for at least one protected local area of buildings, rooms or properties is described. The device includes at least one master unit having the following components: a monitor, a camera, a loudspeaker, a microphone, at least one function key, a controller, a memory and a signal and data transmission device with a network interface for signal transmission to and from at least one distant station via an IP network. As an additional component, the master unit comprises a reader for reading ID numbers stored on ID cards as an identification feature.

### BACKGROUND OF THE INVENTION

1. Field of the Invention

The present invention relates generally to access, monitoring and communication devices and methods used to provide, block or monitor the access of persons to or in safety-relevant areas and also to monitor the safety-relevant areas themselves.

2. Description of the Prior Art

A prior art device comprises a terminal with a monitor, a loudspeaker, a microphone, a call button and/or keypad and a door opener driver. As an option, an external camera can also be connected to the terminal.

The terminal and further terminals, if necessary, are connected with a central station which provides a signal and data connection between other terminals. A network interface for signal and data transmission to a further terminal is also mentioned.

### SUMMARY OF THE INVENTION

The object of the invention is to provide an access, monitoring and communication device which in addition to an ID number can also record further specific personal data and communicate and exchange data via a distant station without a detour, i.e., directly.

The terms used in the description and the claims are defined as follows:
“ID number” is a number that is assigned to a person or a user which is electronically stored on an identification card and can be electronically read.
“Biometric features” are the biometric features read by a reader, such as fingerprints, iris image and face image, of a person who has been assigned an ID number.
“PIN” is a secret character sequence known only to one person, which is entered manually with a keypad and has been assigned to an ID number.
“Identification features” are individual or logically linked features from among the following: read ID number, read biometric features, and PIN entered. Identification features are data filed in a memory of a master and/or secondary unit and/or server for comparison with identification features.
“Access profile” is a list of accessible and/or blocked areas and access doors to these areas which has been assigned to a person.
“Time profile” is a list of time sections assigned to a person, such as time of day, weekly schedule and date, in which access is permitted for the persons or in connection with the access profile, or an access request is refused.
“Access data” are individually or logically linked identification data, access profiles and time profiles filed in a memory of a master and/or secondary unit and/or server.
“Events” are individual or combined activities acquired by the master and/or secondary unit from among the following: identification features, identification card read or not read, biometric features read or not read, PIN entered or not entered, biometric features and/or PIN assigned or not assigned to the ID number, pressing of a function key, access to the access profile permitted or not permitted, access to the time profile permitted or not permitted, door not opened, door open too long, door blocked, door forced open, camera image recorded or not recorded, camera image concealed, camera image manipulated, network failure, and network activated. The events are respectively linked with a timestamp made up of time of the day and date.
“Historical data” are events buffered in the master and/or secondary unit, optionally further linked with still image and/or full-motion image sequences and/or voice recordings.

With a reader being provided as a component of the master unit for reading ID numbers stored on identification cards as part of the identification features, a local authentication of users can be performed by comparison with access data stored in unencrypted or encrypted form. This enables quick and secure identification without establishing a connection via the network to a server or to a distant station. If required, access data between the memory of the master unit and the server can be loaded, deleted, exchanged, verified and updated via the IP network.

The master unit can comprise at least one further interface for data and/or signal transmission to and from at least one secondary unit. Because of this, a connection to a secondary unit can be established independently of the IP network.

The at least one secondary unit can be connected with the master unit, whereby the secondary unit can comprise as components a controller with a processor, a memory and a signal and data transmission unit with an interface to the master unit and a reader for identification features.

The secondary unit can perform local authentication of users with access data stored in unencrypted or encrypted form, and access data between the memory of the master unit and the memory of the secondary unit can be loaded, deleted, exchanged, verified and updated.

The secondary unit can in addition comprise a network interface for signal and data transmission to and from the at least one server and/or a master unit and/or the at least one distant station via the IP network. Through this, a direct signal and data transmission to and from the at least one server and/or one master unit and/or the at least one distant station can take place.

The master and/or secondary unit can additionally comprise at least one further interface for signal and data transmission to and from the at least one server and the at least one distant station over at least one further network from among a mobile dial-up network, particularly a GSM network or a fixed switch network, particularly an ISDN network or analog network.

The transmission reliability can be ensured through a further network, for example during malfunction of a global IP network. In this manner, time-critical data can be transmitted to the memory of the master and/or secondary units via a redundant data channel.

As an additional component, the master and/or secondary unit can comprise a reader for reading biometric features as part of the identification features. As a result, the identification reliability can be further improved. In this manner, the access of an unauthorized person with a stolen or copied identification card can be prevented.

As an additional component, the master and/or secondary unit can comprise a keypad for entering a PIN. Hereby too, the identification reliability can be further improved.

The access data assigned to the master unit and/or a secondary unit can be stored in the memory of the master unit and/or secondary unit in unencrypted or encrypted form for comparison with acquired identification features. In the event of encrypted storage of access data, an unauthorized person will find it difficult or impossible to obtain the access data by stealing the master unit or the secondary unit and reading the memory, or to manipulate access data in order to generate and use falsified identification cards. The described advantage of encrypted storage also applies for other types of data, such as programs, codecs and historical data.

In the memory of the master and/or secondary unit, access profiles can be stored in unencrypted or encrypted form as a constituent of the access data. As a result, users with different access authorizations can be distinguished in accordance with their personal security hierarchical level and the security level of the protected areas.

In the memory of the master and/or secondary unit, time profiles can be stored in unencrypted or encrypted form as part of the access data. In this manner, individual and general time frames can be determined during which users can have access. Moreover, chronological standards for destinations of the transmission of signals and data to servers and distant stations can also be taken into account.

The access data assigned to the master unit and the access data assigned to the connected secondary units for a comparison with identification features can be stored in unencrypted or encrypted form in the memory of the master unit. In this way, the master unit can also manage and update the access data of the connected secondary units.

In the memory of the secondary unit, preferably only the locally assigned access data to the secondary unit are stored in unencrypted or encrypted form for a comparison with identification features. This embodiment makes it possible to uniquely write the access data to the master unit, to transmit them from there to the connected secondary units and to store them. An individual data input to the secondary units is not required.

Assuming that the access data required from a secondary unit is smaller than the sum of the access data stored in the master unit, the secondary unit requires only a smaller and thus lower-priced memory. In addition to a smaller memory requirement for the secondary units, the time for analysis for desired access can be reduced because of the lower number of access data to be compared in the secondary unit, or, if the analysis time is the same as in the master unit, a processor with lower performance can be used. This is advantageous with respect to manufacturing costs and energy requirement, especially if the units are supplied with energy via an Ethernet cable as constituent of the IP network.

The master unit can be permanently or temporarily connected to the server via the IP network for updating the operating software or the access data stored in unencrypted or encrypted form in the memory of the master unit. A permanent connection has the advantage that if the access data in the server are changed, this change is transmitted immediately to the master unit and can be taken into account during subsequent access requests. A temporary transmission can be sufficient if changes occur infrequently and reduces the IP network interface energy requirement.

In the memory of the master and/or secondary unit, the acquired events can be stored in unencrypted or encrypted form in the buffer. It thus becomes possible to log the exact history of all events occurring at the master and/or secondary unit for subsequent verification.

The secondary unit can comprise further components from among the following: monitor, camera, loudspeaker, microphone, and function key. In this way, the secondary unit can be provided with the same functionality with respect to data acquisition and communication with a distant station.

In the memory of the master and/or secondary unit, at least one still image acquired by the camera during an access request or also voice signals acquired by the microphone can be buffered in encrypted or unencrypted form as a compressed data record linked to events.

Through additional acquisition of a still image during an access request, any attempts for manipulation with stolen, loaned or exchanged identification cards can be better detected. The stored image data make it possible to record images of persons performing successful and unsuccessful identification attempts to log attempts for access through assignment of images of the person desiring access and thus make it possible to verify manipulation subsequently.

The master and/or secondary unit can comprise a door opener driver for unencrypted or encrypted generation of door opening signals to a remote door opening system. In this way it is possible to control a remote door opening system in a secure area from a master unit located in an unsecured area. Any manipulation by removal of the master unit and direct activation of the door opener through short-circuiting of contacts is thus prevented.

On one of the interfaces of the master and/or secondary unit at least one application specific module with an interface to the master and/or secondary unit can be connected, and the application specific module can comprise at least one further interface to a peripheral system as output devices from among the following: burglar alarm system, fire alarm system, alarm system, heating, ventilation, air conditioning system, lighting system, elevator system and/or a peripheral from among the following: fire alarms, smoke detectors, gas detectors, water detectors, moisture detectors, temperature sensors, motion detectors, contact switches, glassbreak detectors, photoelectric switches as input devices and optical alarm signaling devices, acoustic alarm signaling devices, dialing equipment, switching devices, controls for heating, ventilation, air conditioning, lighting controllers, and elevator controllers. In this way, the hardware and software of the master unit or the secondary unit can also be utilized for autonomous, intelligent control of technical equipment in buildings.

The application specific module can be a protocol converter. By means of the protocol converter, a data transmission protocol used by the technical equipment in buildings can be converted to the protocol used by the master unit or the secondary unit. The master or secondary unit can then interchangeably use the same interface and the same protocol for data exchange and the control of the technical equipment in buildings for the data exchange.

The application specific module can be a transducer from among the following: analog/digital converters, digital/analog converters, impedance converters, interface converters, wireline/radio transducers. In this way, individual detection devices and sensors of the technical equipment in buildings can be interrogated and controlled from the master or secondary unit.

The controller of the master and/or secondary unit can include a master processor for data processing from among encoding, decoding of access, voice and image data for writing to or reading from the memory; transmitting or receiving of data via the IP network or at least one further network or at least one interface; analysis of data which are received via the IP network or the at least one further network or the at least one interface; analysis of received data from peripheral systems or peripherals; control of peripheral systems or peripherals; autonomous control of peripheral systems or peripherals based upon data received from peripheral systems or peripherals, evaluation of identification features, and generation of unencrypted or encrypted door opening signals. With this solution, the same master processor can be used for all encoding, decoding and control tasks in the master or secondary unit.

The control program stored in the memory in unencrypted or encrypted form which controls the master processor in the controller of the master unit can be an operating-system-independent comprehensive program.

The control program can be compiled in a uniform standard language and be installed and run in all master units independently of their individual operating systems. Preferably, the operating-system-independent comprehensive program uses Java programming language, which is a widely used programming language originally developed by Sun Microsystems. Java programs generally run without further adaptations on various computers and operating systems for which a Java virtual machine exists.

In the memory of the master and/or secondary unit, codecs for signals from among voice signals, still image signals and full-motion image signals can be stored in unencrypted or encrypted form for execution by the master processor and can be loaded and therefore updated. Through this, voice signals and full-motion image signals in standardized protocols can be exchanged with a distant station via the IP network. This can involve protocols which use Internet telephony or Internet video telephones or those utilized by other providers such as Skype or Windows Live Messenger. Furthermore, voice signals, still image signals and full-motion image signals can be stored in compressed form unencrypted or encrypted and be transmitted to the server or to the distant station as files, e.g., in wav, mp3, wma, wmv, jpeg, and mpeg file formats. This can be done in parallel to the other data and via the same IP network or another network.

In the memory of the master and/or secondary unit, menu driven operating instructions can be stored in unencrypted or encrypted form. An inexperienced user can thus initially retrieve operating instructions in communication with the master unit through voice and/or image instructions to perform the specifically required steps for access. In this instance, no communication with a manned distant station is required.

In the memory of the master and/or secondary unit, control programs for execution of programs from among startup, setup and maintenance work by the master processor can be stored in unencrypted or encrypted form. For the startup, setup and maintenance work, the master and/or secondary unit can be installed already or remain installed at its application side. This has the advantage that all work can be performed under realistic conditions of use.

The components assigned to the master or secondary unit from among the following: reader for reading ID numbers, reader for reading biometric features, and keypad for input of a PIN, can be arranged outside of the master unit or secondary unit in an unprotected area. Access requests can therefore be entered outside of a protected area, while monitoring of the protected area can also be executed directly or emergency calls can also be transmitted from the protected area itself.

In the memory of the secondary unit, access data transmitted from the master unit to the secondary unit can be stored in unencrypted or encrypted form. The secondary unit, after receiving data from the master unit, can in this way grant access authorization or refuse access requests autonomously, e.g., during malfunctions of the master unit or interruption of the data line to the master unit.

A control program for controlling a selective data transfer of the locally required access data to the respective secondary unit can be stored in the memory of the master unit in unencrypted or encrypted form. As a result, the master unit can instantly provide the secondary unit with all necessary programs and data without requiring a connection with the server.

A control program for retrieval and inherent storage of the locally required access data from the memory of the master unit can be stored in the memory of the secondary unit in unencrypted or encrypted form. With this alternative, the secondary unit itself can also request the required programs and data, without requiring any initiation from the master unit.

A control program for automatic translation of a control program written in a standard language into an abstracted, but functionally equivalent control program of the respective secondary unit, as well as for conversion of a database with standardized data records from the master unit into a database with compressed data records of the respective secondary unit and for transmission to the respective secondary unit, can be stored in unencrypted or encrypted form in the memory of the master unit. This makes it possible to program the secondary unit automatically from the master unit. At the same time, the storage space and the processor capacity, which would otherwise be needed for the standard language, and a program translator for a virtual machine and for interrogation of a database with standardized data records, are no longer necessary.

A control program for controlling the comparison between identification features and compressed access data can be stored in unencrypted or encrypted form in the memory of the secondary unit, whereby the compressed access data from standardized data records prepared in compressed data records by the master unit or the server are converted to compressed data records and stored in unencrypted or encrypted form in the memory of the secondary unit. Through this, the data records previously generated in the master unit or the server can also be analyzed by the secondary unit. By limiting the comparison to compressed data records prepared only for the secondary unit, it can be simplified and accelerated.

In the memory of the master and/or secondary unit and/or server, a web server and/or web browser executed by the master processor in the master and/or secondary unit and/or server can be stored in unencrypted or encrypted form. In this way, using a standardized web browser of the distant station, the server, the master unit or the secondary unit, data from the server, master and/or secondary unit can be received or entered into them and structures of the device can be represented.

The invention furthermore has an object to execute autonomous, fast and secure authentication by means of an access, monitoring and communication device.

By comparing identification features with access data stored in the memory of the master and/or a secondary unit in unencrypted or encrypted form and assigned to the master and/or secondary unit, the local authentication of users can be performed rapidly and securely. Moreover, access data can be loaded, deleted, exchanged, verified and updated between the master unit and the server via the IP network.

Prior to the comparison, the stored encrypted access data can be decrypted. As a result, the data comparison is simplified and unique.

The access data assigned to the master and/or secondary unit can be managed from the server, and in case of changes, updated access data can be transmitted via the IP network or one of the other networks to the master unit and be stored in the memory of the master unit in unencrypted or encrypted form. Through this, the data maintenance of the master and/or secondary units is centrally performed and significantly simplified. At the same time, updated access data are available for all master and/or secondary units.

An IP network connection and/or a connection that exists via one of the other networks between the server and the master unit can be monitored by the server and/or by the master unit and after failure and subsequent restoration of the IP network connection and/or the other network connection, a check for changed access data can be performed by the server directly or by the server upon request by the master unit. In case of temporary change of the access data assigned to the master unit during the failure of the IP network connection or the other network connection, updated access data can be transmitted to the master unit via the IP network and/or the other network and be stored in the memory of the master unit in encrypted form.

If an IP network connection exists, updated data are normally transmitted immediately to the master and/or secondary unit. In the case of pending updates during malfunction of the IP network connection, unconnected master and/or secondary units cannot receive data. The situation is detected by monitoring, and an additional transmission is performed upon restoration of the IP network connection. In this manner, no updates are lost.

The required identification features can be buffered as identification data in the memory of the master or secondary unit in unencrypted or encrypted form, be transmitted to the server, and stored in a memory of the server. This makes it possible to log an exact history of successful and refused attempts for access for subsequent verification.

Data between the master and/or secondary unit and the at least one server and the at least one distant station can be transmitted generally or on-demand optionally or additionally via a further interface and/or at least one further network from among the following: mobile dial-up network, particularly GSM network, or fixed switch network, particularly ISDN network or analog network.

The transmission reliability can be ensured through a further network, for example during malfunction of a global IP network. This allows time-critical data to be transmitted to the memory of the master and/or secondary units via a redundant data channel.

Additionally or alternatively, biometric data can be acquired and analyzed by the master and/or secondary unit. As a result, the identification reliability can be further improved. In this way, the access of an unauthorized person with a stolen or copied identification card can be prevented.

Additionally or alternatively, keypad entries of a PIN can be acquired and analyzed by the master and/or secondary unit. Hereby too, the identification reliability can be further improved.

The access data assigned to the master unit or secondary unit can be stored and analyzed by the master and/or secondary unit in unencrypted or encrypted form for a comparison with identification features. In the event of encrypted storage of access data, an unauthorized person will find it difficult or impossible to obtain the access data by stealing the master unit or the secondary unit and reading the memory or to manipulate access data in order to generate and use falsified identification cards. The described advantage of encrypted storage also applies for other types of data, such as programs, codecs and historical data.

Access profiles can be stored and analyzed by the master and/or secondary unit in unencrypted or encrypted form. Because of this, users with different access authorizations can be distinguished in accordance with their personal security hierarchical level and security level of the protected areas.

Time profiles can also be stored and analyzed by the master and/or secondary unit in unencrypted or encrypted form. In this manner, individual and general time frames can be determined during which users can have access. Moreover, chronological standards for destinations of the transmission of signals and data to servers and distant stations can also be taken into account.

The access data assigned to the master unit and the access data assigned to the connected secondary units can be stored and analyzed in unencrypted or encrypted form by the master unit for a comparison with identification features. The master unit can thus also manage and update the access data of the connected secondary units.

Preferably, only the local access data assigned to the secondary unit are stored and analyzed in unencrypted or encrypted form by the secondary unit for a comparison with identification features. This embodiment makes it possible to uniquely write the access data to the master unit, to transmit them from there to the connected secondary units and to store them. An individual data input to the secondary units is not required.

Assuming that the access data required from a secondary unit is smaller than the sum of the data stored in the master unit in unencrypted or encrypted form, the secondary unit requires only a smaller and thus lower-priced memory. In addition to a smaller memory requirement for the secondary units, the time for analysis for desired access can be reduced because of the lower number of access data to be compared in the secondary unit, or, for identical analysis time as in the master unit, a processor with lower performance can be used.

The master unit can be permanently or temporarily connected to the server via the IP network for updating the operating software or the access data stored in unencrypted or encrypted form in the memory of the master unit. A permanent connection has the advantage that if the access data in the server are changed, this change is transmitted immediately to the master unit and can be taken into account during subsequent access requests. A temporary transmission can be sufficient if changes occur infrequently and it reduces the IP network interface energy requirement.

The events acquired in the memory of the master and/or secondary unit can be buffered as historical data in unencrypted or encrypted form in the memory of the master and/or secondary unit. This makes it possible to log an exact history of successful and refused attempts for access for subsequent verification.

In the memory of the master and/or secondary unit, at least one still image acquired by the camera during an access request can be buffered as historical data in an encrypted or unencrypted form as a compressed data record linked to events.

Through additional acquisition of a still image during an access request, any attempts for manipulation with stolen, loaned or exchanged identification cards can be better detected. The stored unencrypted or encrypted image data make it possible to acquire images of persons performing successful and unsuccessful identification attempts, to log attempts for access through assignment of images of the person desiring access and thus make it possible to verify manipulation subsequently.

Unencrypted or encrypted door opening signals can be generated by means of a door opening driver in the master and/or secondary unit and be transmitted wireless or by wireline to a remote door opening system. In this way it is possible to control a remote door opening system from a master unit located in an unsecured area. This prevents any manipulation by removal of the master unit and direct activation of the door opener through short-circuiting of contacts.

Through one of the interfaces of the master and/or secondary unit at least one application specific module with an interface to the master and/or secondary unit and at least one further interface to a peripheral system can be controlled as output devices from among the following: burglar alarm system, fire alarm system, alarm system, heating, ventilation, air conditioning system, lighting system, elevator system and/or a peripheral from among the following: fire alarms, smoke detectors, gas detectors, water detectors, moisture detectors, temperature sensors, motion detectors, contact switches, glass break detectors, photoelectric switches as input devices and optical alarm signaling devices, acoustic alarm signaling devices, dialing equipment, switching devices, controls for heating, ventilation, air conditioning, lighting controllers, and elevator controllers. In this way, the hardware and software of the master unit or the secondary unit can also be utilized for autonomous, intelligent control of technical equipment in buildings, that is, when autonomous decisions can be made during a temporary failure of an IP network.

Protocols between the interfaces can be converted through the application specific module. By means of conversion of protocols, a data transmission protocol used by one of the technical equipment in buildings can be converted to the protocol used by the master unit or the secondary unit. The master or secondary unit can then interchangeably use the same interface and the same protocol for data exchange and the control of the technical equipment in buildings.

Through the application specific module, a signal conversion can be performed from among the following: analog/digital conversion, digital/analog conversion, impedance conversion and interface conversion, and wireline/radio transducer. In this way, also individual detection devices and sensors of the technical equipment in buildings can be interrogated and controlled from the master or secondary unit.

Through a master processor of the controller of the master and/or secondary unit, data processing can be performed from among encoding, or decoding of access, voice and image data for writing to or reading from the memory; transmitting or receiving of data via the IP network or at least one further network or at least one interface; analysis of data which are received via the IP network or the at least one further network or the at least one interface; analysis of received data from peripheral systems or peripherals; control of peripheral systems or peripherals; autonomous control of peripheral systems or peripherals based upon data received from peripheral systems or peripherals, evaluation of identification features, and generation of door opening signals in unencrypted or encrypted form. With this solution, the same master processor can be used for all encoding, decoding and control tasks in the master or secondary unit. All programs and subprograms can therefore be generated as a common program package and run on the same platform.

In the master processor in the controller of the master unit, an operating-system-independent comprehensive control program can be executed. The control program can be compiled in a uniform standard language and can be installed and run in all master units independently of their individual operating systems. The operating independent comprehensive control system executed is preferably Java. Java programs generally run without further adaptations on various computers and operating systems for which a Java virtual machine exists.

In the master processor in the controller of the master and/or secondary unit, codecs for signals can be executed from among voice signals, still image signals, and full-motion image signals. Through this, voice signals and full-motion image signals in standardized protocols can be exchanged with a distant station via the IP network. This can involve protocols which use Internet telephony or Internet video telephones or those utilized by other providers, such as Skype or Windows Live Messenger. Furthermore, voice signals, still image signals and full-motion image signals can be stored in compressed form unencrypted or encrypted and be transmitted to the server or to the distant station as files, e.g., in wav, mp3, wma, wmv, jpeg, mpeg file formats. This can be done in parallel to the other data and via the same IP network or another network.

In the master and/or secondary unit, menu driven operating instructions can be stored in unencrypted or encrypted form and be executed. An inexperienced user can thus initially retrieve operating instructions in communication with the master and/or secondary unit through voice and/or image instructions in order to perform the specifically required steps for access. In this instance, no communication with a manned distant station is required.

Control programs can be stored in the master and/or the secondary unit in unencrypted or encrypted form and be executed for performing from among the following: startup, setup and maintenance work. For the startup, setup and maintenance work, the master and/or secondary unit can already be installed or remain installed at its application side. This has the advantage that all work can be performed under realistic conditions of use.

Access data can be transmitted from the master unit to the secondary unit and stored in the memory of the secondary unit in unencrypted or encrypted form. The secondary unit, after receiving data from the master unit, can in this way grant access authorization or refuse access requests autonomously, e.g., during malfunction of the master unit or interruption of the data line to the master unit.

A control program for controlling selective data transfer of the locally required access data to the respective secondary unit can be stored in unencrypted or encrypted form in the master unit and be executed. As a result, the master unit can instantly provide the secondary unit with all necessary programs and data without requiring a connection with the server.

A control program for retrieval and inherent storage of the locally required access data from the memory of the master unit can be stored in the secondary unit in unencrypted or encrypted form and be executed. With this alternative, the secondary unit itself can also request the required programs and data, without requiring any initiation from the master unit.

A control program for automatic translation of a control program compiled in a standard language into an abstracted, but functionally equivalent control program of the respective secondary unit and for transmission to the secondary unit can be stored in the master unit or server in unencrypted or encrypted form and be executed.

Independently or jointly, also a control program for conversion of a database with standardized data records from the master unit or the server to a database with compressed data records of the respective secondary unit and for transmission to the respective secondary unit can be stored in unencrypted or encrypted form and be executed. This makes it possible to program the secondary unit automatically from the master unit or from the server. At the same time, the storage space and the processor capacity, which would otherwise be needed for the standard language, a program translator and for a virtual machine and/or for interrogation of a database with standardized data records, are not necessary.

A conversion program for converting standardized data records of access data to compressed data records with compressed field contents from the access data which were prepared from the master unit or from the server and transmitted to the secondary units data can be stored in unencrypted or encrypted form in the secondary unit and be executed. Through this, the data records previously generated in the master unit or the server can also be analyzed by the secondary unit. By limiting the compressed data records that were prepared only for the secondary unit, the comparison can be simplified and accelerated.

A web server and/or web browser can be executed in the master and/or secondary unit and/or server. In this way, using a standardized web browser of the distant station, the server, the master unit or the secondary unit, data from the server, master and/or secondary unit can be received or entered into it and structures of the device can be represented. Here, the web browser uses the infrastructure of the networked device in order to obtain access to the master, the secondary units or the servers via the web servers existing in the units.

Access from the web server of a secondary unit is generally only possible to the web server of the secondary unit, from the web browser of a master unit only to the web browsers of the master unit and the connected secondary units and from the web browser of a server to the web browsers of the master units and the directly connected secondary units.

However, through extended access rights, web browsers can optionally also represent the overall hierarchy of the device or individual levels or components from among the following: server, master unit, secondary unit, peripheral system, and peripheral. As a result, supported by a graphical user interface, all maintenance and updating work can be performed from one location.

Numerous other objects and advantages of the present invention will be apparent to those skilled in this art from the following description wherein there is shown and described a preferred embodiment of the present invention, simply by way of illustration of one of the modes best suited to carry out the invention. As will be realized, the invention is capable of other different embodiments, and its several details are capable of modification in various obvious aspects without departing from the invention. Accordingly, the drawings and description should be regarded as illustrative in nature and not restrictive.

### BRIEF DESCRIPTION OF THE DRAWINGS

The present invention will become more clearly appreciated as the disclosure of the invention is made with reference to the accompanying drawings. In the drawings:

FIG. 1 is a schematic general arrangement of the device claimed by the invention;

FIG. 2 is a block wiring diagram of a main unit or secondary unit;

FIG. 3 is a schematic representation of connectivity between a master and a secondary unit;

FIG. 4 is a schematic representation of connecting additional systems, sensors, detection devices and transmitters; and

FIG. 5 is a schematic representation of connectivities between master, secondary unit and server.

### DETAILED DESCRIPTION OF THE INVENTION

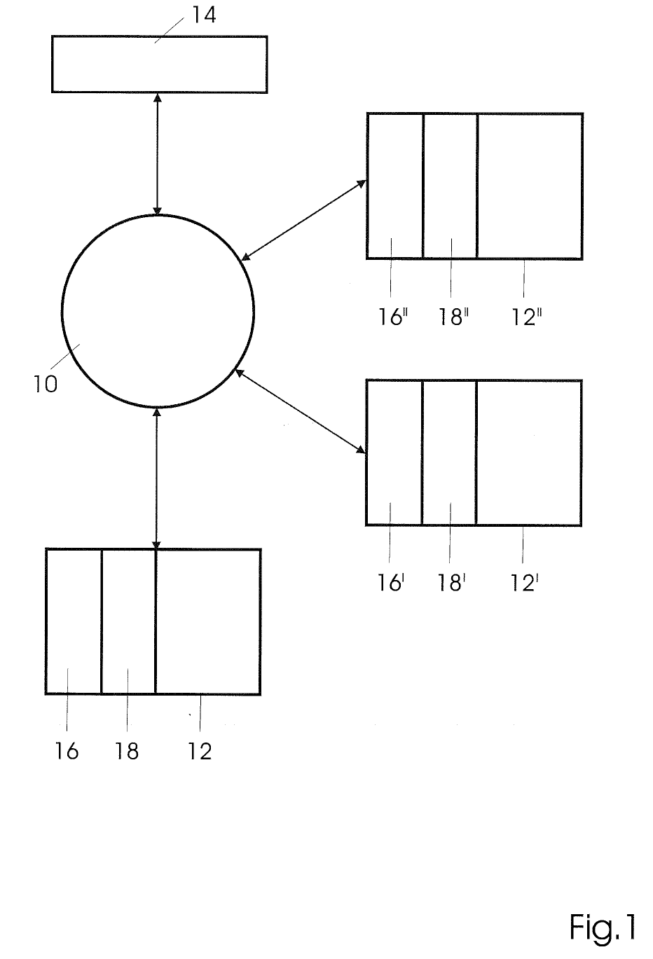

FIG. 1 is a schematic general arrangement of the device claimed by the invention. Via an IP network 10, a plurality of master units 12, 12′, 12″ are permanently or temporarily connected to a server 14. The master units 12, 12′, 12″ contain all necessary components for monitoring and controlling a request for access to a protected area. The master units 12, 12′, and 12″ also comprise a web server 16, 16′, 16″ and web client 18, 18′, 18″. The master units 12, 12′, 12″ process access requests autonomously, but can also transmit user generated identification data to server 14 or receive updated access data and control software from server 14. With the IP network 10, this involves a network using the Internet protocol. This can be a public network, such as the Internet, or also a private network, such as the Intranet. Wireless radio networks, such as WLAN, Bluetooth or ZigBee are also possible.

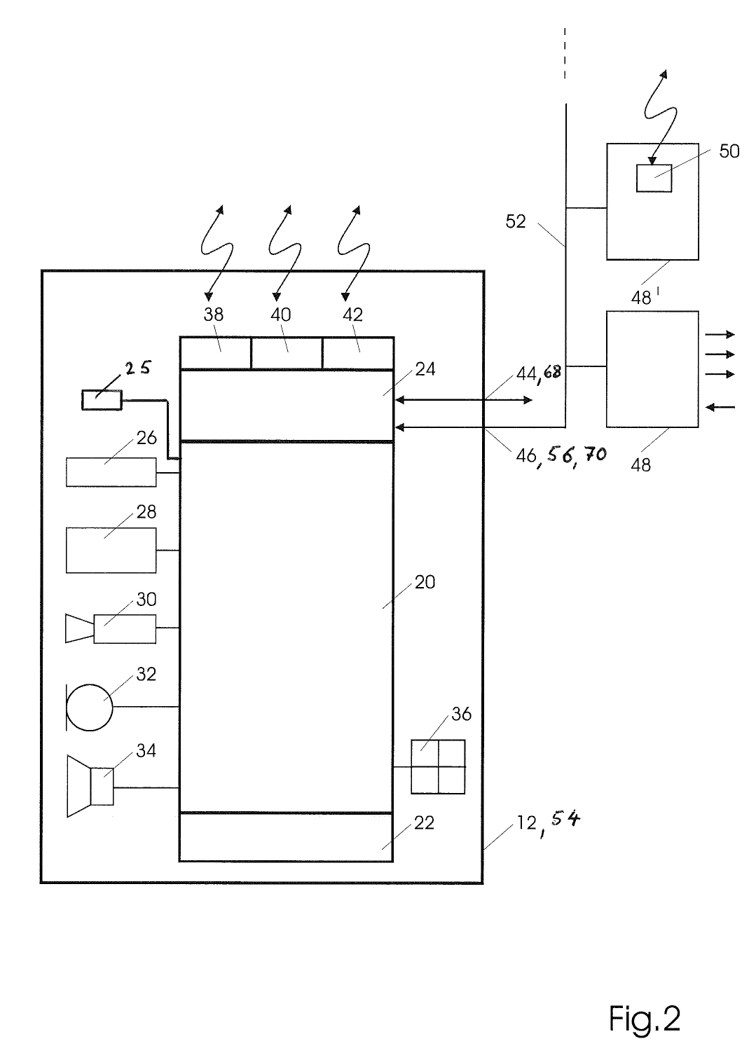

FIG. 2 shows a block wiring diagram of a master unit 12 or secondary unit 54. The master unit 12 or secondary unit 54 comprises a controller 20 with a master processor, a memory 22 and a signal and data transmission unit 24. An identification card reader 25, a reader 26 for biometric features, a monitor 28, a camera 30, a microphone 32, a loudspeaker 34 as well as function keys and/or a keypad 36 are connected to the controller 20. The identification card reader 25, the reader 26 for biometric features, the monitor 28, the camera 30, the microphone 32, and the loudspeaker 34 can be in various forms and can be built into the master unit 12 or the secondary unit 54, as shown in FIG. 2, or can be remote therefrom. At the same time, the master unit 12 or secondary unit 54 can, for example, be arranged in a protected area, while the remote components are installed in an unprotected area.

The signal and data transmission unit 24 is connected with an IP network via IP interface 44, 68, which can involve a public WAN network or a local LAN network. Furthermore, radio modules 38, 40, 42, which are integrated in the master unit 12 and the secondary unit 54, are connected to the signal and data transmission unit 24. The radio modules include a GSM radio module 38, a WLAN radio module 40, and an ISM radio module 42. In addition, a further interface 46, 56, 70 is connected to the signal and data transmission unit 24, for connecting to a further IP network, a data bus, a data line, or directly to an external component.

An application-specific module 48 is connected to the further interface 46, 56, 70, through which technical equipment in buildings, sensor transmitters or actuators can be connected. The example represented in FIG. 2 is a radio module 50, which is controlled from the application-specific module 48 and enables a door opening system by radio. Alternatively, the door opening system can be radio-controlled through the ISM radio module 42.

Access data for verification of access requests and control programs for controlling the controller 20 are stored in memory 22. Codecs for voice signals, full-motion images and still images can also be stored in memory 22. Moreover, ID numbers from identification cards read by reader 25, biometric features read by reader 26, PINs entered with keypad 36, still image or full-motion images taken by camera 30, and voice signals recorded by microphone 32, can also be buffered.

For increased security, all data and programs can be stored in encrypted form. The signal in data transmission unit 24 manages the IP interface 44, 68 and the further interface 46, 56, 70 and controls the transmission and receiving of data via this interface. Furthermore, radio modules 38, 40 and 42 are also controlled by the data transmission unit 24.

In the representation according to FIG. 2, the identification card reader 25, the reader 26 for biometric features, the monitor 28, the camera 30, the microphone 32, the loudspeaker 34, and the function keys or the keypad 36 are integrated in the housing of the master unit 12 or the secondary unit 54. It is also possible, however, to arrange individual or several components outside of the housing of the master unit 12 or the secondary unit 54. Thus, images from other perspectives or rooms can be acquired by means of one or several cameras 30. The loudspeaker 34 can also consist of individual or several loudspeakers, so that announcements can be heard in other areas or rooms, for example.

An operating system independent comprehensive control program, such as Java, is stored in the memory 22 of the master unit 12 and executed by the master processor of the controller 20. An abstracted but functionally equivalent control program is stored in the memory 22 of the secondary unit 54, which is executed by the master processor of the controller 20.

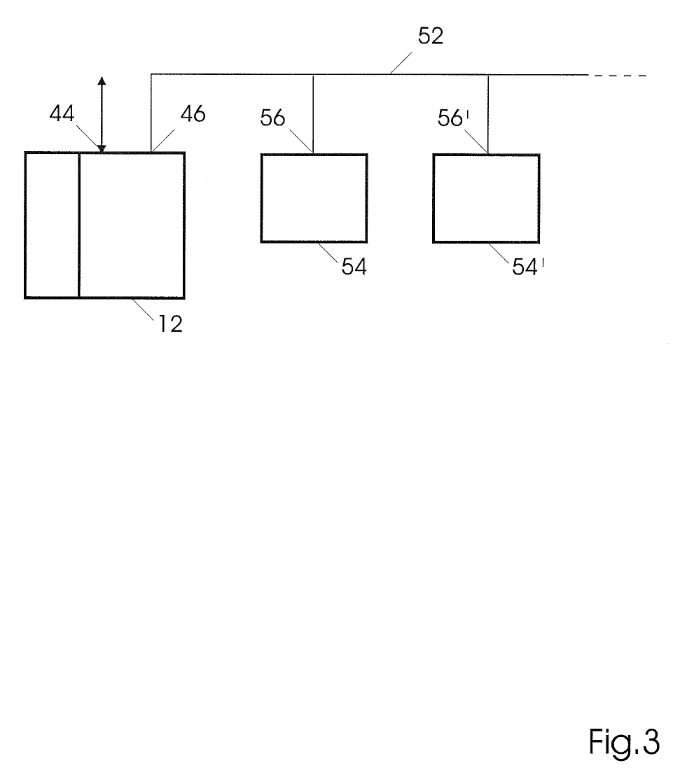

FIG. 3 is a schematic representation of the connection between a master unit and a secondary unit. The master unit 12 is connected via the additional interface 46 and a data bus 52 with secondary units 54, 54′ via their interfaces 56, 56′. When the secondary units 54, 54′ are managed from the master unit 12, they can be equipped with simpler and more cost-effective components, compared to the master unit 12. In this case, a connection exists merely from master unit 12 to a server 14 via an IP network, while the secondary units 54, 54′ receive access data and program data processed from the master unit 12 via the data bus 52.

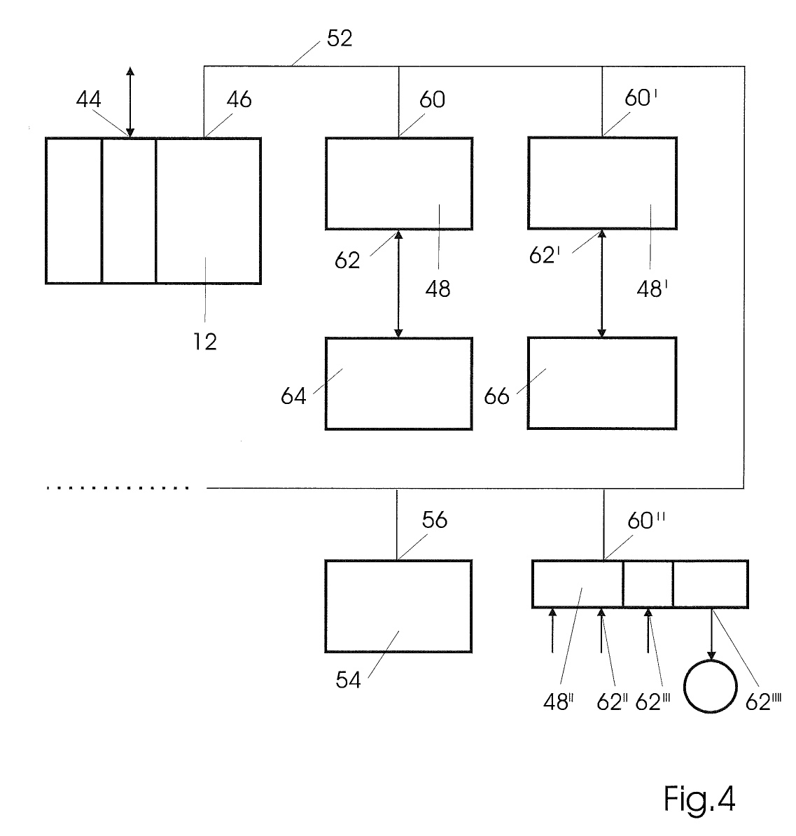

FIG. 4 is a schematic representation of a further connectivity between master unit 12 and secondary unit 54. In this case, application-specific modules, 48, 48′, 48″ are connected via their interfaces 60, 60′, 60″ to the data bus 52 between the master unit 12 and the secondary unit 54. The application-specific modules 48, 48′, 48″ are used to integrate technical equipment in buildings as well as sensors, detection devices and actuators. The application-specific modules 48, 48′, 48″ also serve for conversion of interfaces and protocols.

Thus, in the representation, a burglar alarm system 64 is connected to an interface 62 of the application-specific module 48, and a fire alarm system 66 is connected to an interface 62′ of the application-specific module 48′. Sensors, detection devices and actuators can be connected to the application-specific module 48″ via corresponding interfaces 62″, 62′″, 62″″. Typical examples for this are motion detectors, fire detectors, temperature sensors as sensors and/or detectors, or switching devices or electromechanical components as actuators.

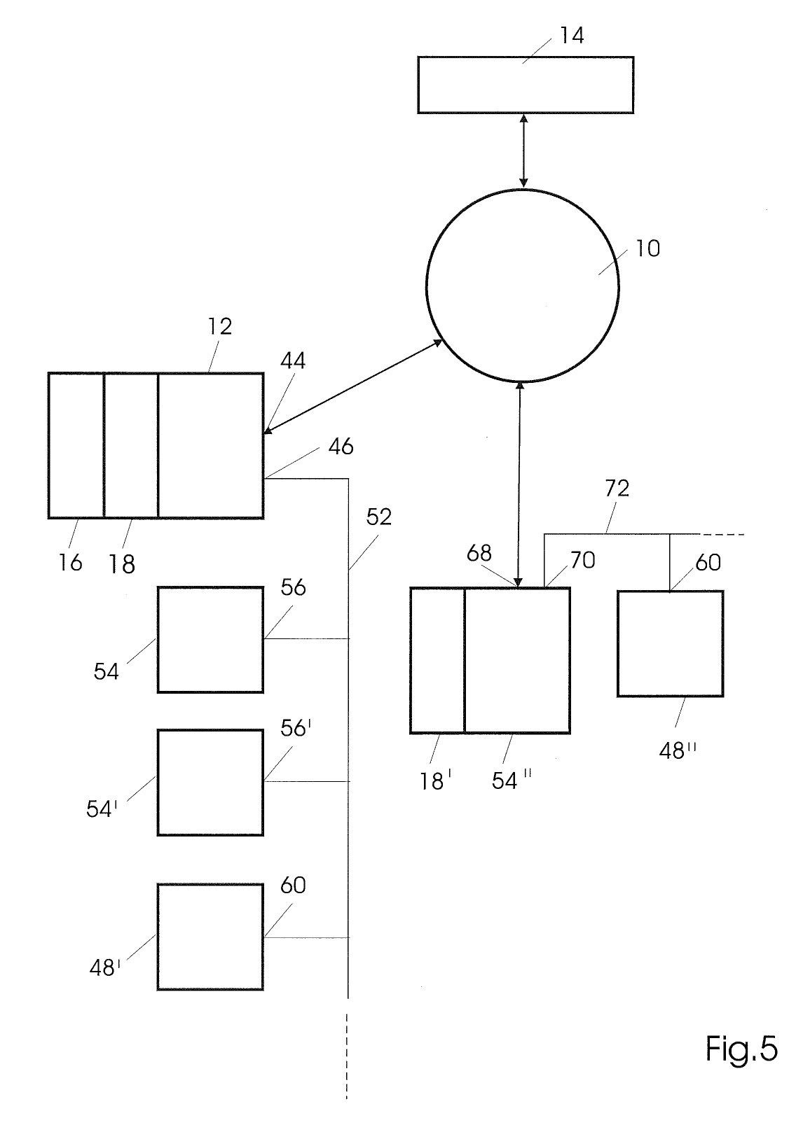

FIG. 5 is a schematic representation of connectivities between master unit 12, secondary units 54, 54′, 54″ and server 14. Two secondary units 54, 54′ and an application-specific module 48′ are connected to the interface 46 of a master unit 12. The master unit 12 can communicate with a server 14 via an IP interface 44 via an IP network 10. In addition it also represents the possibility that a secondary unit 54″ can likewise comprise an IP interface 68 and communicates via an IP network 10 directly with the server 14 or a master unit 12. The secondary unit 54″ for its part can communicate via a further interface 70 with the data bus 72 with an application-specific module 48″ via its interface 60.

In the following, a few application scenarios for the device claimed by the invention are described.

If a user desires access to a secure area, he holds an identification card, on which an ID number is stored, in front of reader 25. A transponder with a memory can be arranged on the card, so that the ID number can be read by reader 25 without making contact. The processor of the controller 20 thereupon compares the read ID number with access data filed in memory 22. If the comparison is positive, access is granted, in that the controller 20 generates an encrypted door opening signal via the signal and data transmission unit 24, which is transmitted to an application-specific module 48 and further to a radio module 50. The radio module 50 in turn provides a radio-controlled door opening system to a door connected therewith. The transmission to a radio-controlled door opening system can also be made via an ISM radio module 42 connected to the signal and data transmission unit 24.

In order to prevent access by unauthorized persons with a stolen or loaned identification card, biometric features, such as a fingerprint, can also be requested and read by a further reader 26. The controller 20 then additionally compares the biometric features stored on the identification card or in memory 22 with biometric features read by reader 26.

After positive authentication of the identification card and the user associated therewith, the controller 20 then compares the identification features with access data, and if they agree generates a door opening signal.

Alternatively or additionally to the biometric data, a PIN can also be retrieved, which is entered through a keypad 36 by the user. In this case, the controller 20 additionally compares that the PIN entered agrees with a PIN stored on the identification card or in memory 22.

For later logging and verification of the data read or entered, the identification data, biometric data and PINs, can also be buffered in memory 22. Linked to these stored data, event data, such as time of day and date, can also be stored. In addition, images of the persons desiring access recorded by the camera 30 can be acquired and be buffered as at least one still image in compressed form together with the other data.

Apart from the access data, access profiles can also be stored in memory 22 and be taken into account during the comparison. Such access profiles can, for instance, identify hierarchy levels of the users as well as security levels of the protected areas. It can thus be determined that users have access only to certain secure areas, while an access request to other areas is refused.

Alternatively or in addition to the access profiles, time profiles can also be stored which are likewise compared additionally to the access data. With the help of these time profiles, times of day, weekly schedules and dates can be determined on which users are granted access or an access request is refused.

The access data, access profiles and time profiles stored in one or several master units 12 and/or secondary units 54 are managed in a server 14, which has a permanent or a temporary connection via an IP network 10. From this server 14, the connected master units 12 and/or secondary units 54 are loaded with access data, access profiles and time profiles for the first time.

If changes are made to these data on the server 14, updated data can be transmitted to the master and/or secondary units affected by these changes and be stored there. In order to reduce manipulation on the master and/or secondary units, all data can be stored in encrypted form in the respective memories 22. Apart from the access data, authorization profiles and time profiles, also program files and codecs can be transmitted from the server via the IP network 10 to the master units 12 and/or secondary units 54 where they can be stored in encrypted or unencrypted form.

By the same token, also buffered user data, i.e., identification data, biometric data, PINs, still image data of the camera together with event data, such as time, date, access granted, desired access refused, and camera image not acquired, can be transmitted to server 14 and be stored there in order to perform centralized data backup for logging and monitoring purposes.

While master units 12 and secondary unit 54 generally have an IP network connection to a server 14, secondary units 54 can also communicate exclusively only via a further interface 56 with an assigned master unit 12 via a data bus 52 or a data line. In this case, apart from the own access data, access profiles and time profiles, also the access data, access profiles, time profiles, and control programs of the connected secondary units 54 can be managed and updated via the further interface 46, 56, when needed.

If a program written in a standard language is executed in the memory 22 of the master unit 12, it can be automatically translated into an abstracted but functionally equivalent control program which runs on the secondary unit 54. Furthermore, a database from standardized data records executed on the master unit 12 can be converted to a database from compressed data records which is executed on the secondary unit 54. The program and database conversion can also be performed by server 14, when secondary units 54 communicate directly with the server 14. Due to more machine-oriented programming and a faster access to the data records, the secondary unit 54 needs less processor capacity at the same sweep speed compared to the master unit 12. Also the memory capacity of the secondary unit 54 can be sized smaller compared to the master unit 12.

The master unit 12 or also the secondary unit 54 can in addition also communicate in video telephony with a distant station, provided it is equipped with additional components of monitor, camera, microphone and loudspeaker. For this purpose, the received and transmitted video and voice data are translated into a protocol in controller 20 by means of stored codecs in memory 22, which can be transmitted as livestream via the IP network 10. The distant stations can be other master units, secondary units, PCs or IP telephones which are familiar with the SIP standard.

In order to establish the connection, the user actuates a function key 36 on the master unit 12 or secondary unit 54 which then starts a preprogrammed call setup. Other connections can also be activated subject to time control.

Technical equipment in buildings, sensors, detection devices and transmitters can also be connected to the further interface 46, 56 of the master and/or secondary unit. In order to facilitate compatibility between the further interface 46, 56 and the systems, detectors, sensors and actuators, these are connected via an application-specific module 48, 58 with the further interface 46, 56, 70 or data bus or data line connected to the interface. The application-specific module 48 then functions as a protocol converter, interface converter or D/A or A/D transducer. In this case, the infrastructure of the device as claimed by the invention is also used for the management, control and forwarding of signals and data of the technical equipment system in the building, detectors, sensors or actuators.

In addition, a maintenance and setup program can also be stored in the master and/or secondary units for call up. At the same time, the individual components can be adjusted and checked for functionality, for instance. It is thus possible for example that the camera image can be diverted to the inherent monitor in order to organize the camera for a user.

Also Web servers and web clients can be stored on the master and/or secondary units and/or the server for execution as needed. In this way, the infrastructure and hardware can be used in order to represent the structure and linking on a graphical user interface at different levels to manage, or also to manage it for individual master or secondary units. For this purpose, the respective web server generates data in a protocol that can be transmitted via an IP network, while the web client presents the data on a graphical user interface as a browser.

While the invention has been specifically described in connection with specific embodiments thereof, it is to be understood that this is by way of illustration and not of limitation, and the scope of the appended claims should be construed as broadly as the prior art will permit.

What is claimed is:

1. An access, monitoring and communication device for at least one protected local area of buildings, rooms or properties, comprising:
at least one master unit comprising a monitor, a camera, a loudspeaker, a microphone, at least one function key, a controller, a memory and a signal and data transmission device with a network interface for signal transmission to and from at least one distant station via an IP network;
said master unit further comprising a reader for reading identification features stored on identification cards.

2. The access, monitoring and communication device according to claim 1, wherein a server for data transferred to and from the at least one master unit is also connected to the IP network via a network interface, and wherein the IP network is a network using an Internet protocol.

3. The access, monitoring and communication device according to claim 1, wherein the at least one master unit comprises at least one additional interface for data and signal transmission or data transmission or signal transmission to and from at least one secondary unit.

4. The access, monitoring and communication device according to claim 3, wherein at least one secondary unit is connected to the master unit, and wherein the secondary unit comprises a controller with a processor, a memory and a signal and data transmission unit with an interface to the master unit, and a reader for reading identification features.

5. The access, monitoring and communication device according to claim 4, wherein the secondary unit further comprises a network interface for signal and data transmission to and from at least one of a server and a distant station via the IP network.

6. The access, monitoring and communication device according to claim 4, wherein the master or secondary unit comprises at least one additional interface for signal and data transmission to and from among at least one server and distant station via at least one of a mobile dial-up network, a fixed switch network, and an analog network.

7. The access, monitoring and communication device according to claim 4, wherein the master or secondary unit further comprises a reader for reading biometric features as part of the identification features.

8. The access, monitoring and communication device according to claim 4, wherein the master or secondary unit further comprises a keypad for input of a PIN as part of the identification features.

9. The access, monitoring and communication device according to claim 4, wherein in the memory of the master unit at least the assigned access data for a comparison of identification features read by the reader are stored either in unencrypted or encrypted form.

10. The access, monitoring and communication device according to claim 4, wherein access profiles are stored in the memory of the master or secondary unit as part of access data in unencrypted or encrypted form.

11. The access, monitoring and communication device according to claim 4, wherein time profiles are stored in the memory of the master or secondary unit as part of access data in unencrypted or encrypted form.

12. The access, monitoring and communication device according to claim 4, wherein in the memory of the master unit at least the assigned access data and the assigned access data for the connected secondary units for comparison of identification features read by the reader are stored either in unencrypted or encrypted form.

13. The access, monitoring and communication device according to claim 4, wherein in the memory of the secondary unit only the locally assigned access data for comparison with identification features read by the reader are stored in unencrypted or encrypted form.

14. The access, monitoring and communication device according to claim 4, wherein the master or secondary unit is connected with the server via the IP network permanently or temporarily for updating and unencrypted or encrypted storage of the operating software or the access data stored in the memory of the master unit in unencrypted or encrypted form.

15. The access, monitoring and communication device according to claim 4, wherein in the memory of the master or secondary unit identification features linked to events and optionally further linked with still image data or voice data or still image and voice data are stored as historical data and are buffered in unencrypted or encrypted form.

16. The access, monitoring and communication device according to claim 4, wherein the secondary unit includes at least one of the following additional components: monitor, camera, loudspeaker, microphone, and function key.

17. The access, monitoring and communication device according to claim 4, wherein the master or secondary unit includes a door opener driver for unencrypted or encrypted generation of door opening signals to a remote door opener switching module.

18. The access, monitoring and communication device according to claim 4, wherein one of the interfaces of the master or secondary unit includes at least one application specific module with an interface to the master or secondary unit and at least one further interface to a peripheral system as output devices from among the following: burglar alarm system, fire alarm system, alarm system, heating, ventilation, air conditioning system, lighting system, elevator system and/or a peripheral from among the following: fire alarms, smoke detectors, gas detectors, water detectors, moisture detectors, temperature sensors, motion detectors, contact switches, glassbreak detectors, photoelectric switches as input devices and optical alarm signaling devices, acoustic alarm signaling devices, dialing equipment, switching devices, controls for heating, ventilation, air conditioning, lighting controllers, and elevator controllers.

19. The access, monitoring and communication device according to claim 18, wherein the application specific module is a protocol converter.

20. The access, monitoring and communication device according to claim 18, wherein the application specific module is a transducer from among the following: analog/digital converter, digital/analog converter, impedance converter and interface converter.

21. The access, monitoring and communication device according to claim 4, wherein the controller of the master or secondary unit includes a master processor for data processing from among: encoding and decoding of access, voice and image data for writing to or reading from the memory; transmitting or receiving data via the IP network or at least one further network or at least one interface; analysis of data which are received via the IP network or the at least one further network or the at least one interface; analysis of received data from peripheral systems or peripherals; control of peripheral systems or peripherals; autonomous control of peripheral systems or peripherals based upon data received from peripheral systems or peripherals; and generation of door opening signals that are respectively unencrypted or encrypted.

22. The access, monitoring and communication device according to claim 21, wherein a control program is stored in the memory in unencrypted or encrypted form for controlling the master processor in the controller of the master unit, and said control program is an operating-system-independent comprehensive program.

23. The access, monitoring and communication device according to claim 22, wherein the operating-system-independent comprehensive program is a Java language program.

24. The access, monitoring and communication device according to claim 22, wherein in the memory of the master or secondary unit, codecs from among voice signals, still image signals and full-motion image signals are stored in unencrypted or encrypted form for execution by the master processor and can be loaded and updated.

25. The access, monitoring and communication device according to claim 22, wherein menu-driven operating instructions are stored in unencrypted or encrypted form in the memory of the master or the secondary unit.

26. The access, monitoring and communication device according to claim 22, wherein control programs are stored in unencrypted or encrypted form in the memory of the master or the secondary unit for executing programs by the master processor from among the following: startup, setup and maintenance jobs.

27. The access, monitoring and communication device according to claim 4, wherein components are assigned to the master or the secondary unit from among the following: reader for reading of ID numbers, reader for reading of biometric features, and keypad for input of a PIN, and wherein said assigned components are arranged outside of the master unit or the secondary unit in an unprotected area.

28. The access, monitoring and communication device according to claim 4, wherein access data transmitted by the master unit to the secondary unit are stored in unencrypted or encrypted form in the memory of the secondary unit.

29. The access, monitoring and communication device according to claim 4, wherein a control program for controlling a selective data transfer of the locally required access data to the respective secondary unit is stored in unencrypted or encrypted form in the memory of the master unit.

30. The access, monitoring and communication device according to claim 4, wherein a control program for retrieval and intrinsic storage of the locally required access data from the memory of the master unit is stored in unencrypted or encrypted form in the memory of the secondary unit.

31. The access, monitoring and communication device according to claim 4, wherein a control program for automatic translation of a control program written in a standard language into an abstracted, but functionally equivalent, control program of a secondary unit and for transmission to the secondary unit is stored in the memory of the master unit or server in unencrypted or encrypted form.

32. The access, monitoring and communication device according to claim 4, wherein a conversion program for converting standardized data records of access data into compressed data records with compressed field contents from the access data and transmission of the compressed access data to the secondary unit is stored in unencrypted or encrypted form in the memory of the master unit or server.

33. The access, monitoring and communication device according to claim 4, wherein a conversion program for converting standardized data records of access data into compressed data records with compressed field contents from the access data which were prepared from the master unit or from the server and transmitted to the secondary units data is stored in unencrypted or encrypted form in the memory of the secondary unit.

34. The access, monitoring and communication device according to claim 4, wherein in the memory of the master or secondary unit or server a web server or web browser executed by the master processor in the master unit, secondary unit or server, is stored unencrypted or encrypted.

35. An access, monitoring and communication method for at least one protected area, comprising:
providing at least one master unit or secondary unit comprising a monitor, a camera, a loudspeaker, a microphone, at least one function key, a controller, a memory, a signal and data transmission device with a network interface for signal transmission to and from at least one distant station via an IP network, and a reader;
using said reader to read identification features stored on an identification card; and
comparing said identification features with access data assigned to the master unit or secondary unit which are stored in unencrypted or encrypted form in the memory of the master unit or secondary unit.

36. The access, monitoring and communication method according to claim 35, wherein the stored access data are encrypted, and further comprising unencrypting the access data prior to the comparison.

37. The access, monitoring and communication method according to claim 35, wherein the access data assigned to the master or secondary unit are managed by the server, and in case of changes updated access data are transmitted via the IP network or one of the other networks to the master or the secondary unit and are stored in the memory of the master or the secondary unit in unencrypted or encrypted form.

38. The access, monitoring and communication method according to claim 37, wherein an IP network connection and a connection that exists via one of the other networks or an IP network connection or a connection that exists via one of the other networks between the server and the master unit is monitored by the server or by the master unit, and after a failure and subsequent restoration of the IP network connection and the other network connection or the IP network connection or the other network connection, a test for changed access data is performed directly by the server or from the server if so requested by the master unit, and during interim change of the access data assigned to the master unit, during the failure of the IP network connection and the other network connection or the IP network connection or the other network connection, updated access data are transmitted via the IP network and the other network or the IP network or the other network to the master unit and are stored in the memory of the master unit in unencrypted or encrypted form.

39. The access, monitoring and communication method according to claim 35, wherein historical data are buffered in unencrypted or encrypted form in the memory of the master or the secondary unit, are transmitted to the server, and are stored in a memory of the server.

40. The access, monitoring and communication method according to claim 35, wherein historical data between the master or secondary unit and the least one device from among the server and distant station can be transmitted generally or on-demand optionally or additionally via a further transmission medium.

41. The access, monitoring and communication method according to 35, wherein biometric features are additionally or alternatively acquired and analyzed by the master or the secondary unit as a constituent of identification features.

42. The access, monitoring and communication method according to claim 35, wherein keypad entries of a PIN can additionally or alternatively be acquired and analyzed as a constituent of identification features by the master or secondary unit.

43. The access, monitoring and communication method according to claim 35, wherein the access data assigned to the master or secondary unit for comparison of identification features read by the reader are stored and analyzed in unencrypted or encrypted form by the master or secondary unit.

44. The access, monitoring and communication method according to claim 35, wherein authorization profiles are stored and analyzed in encrypted or unencrypted form by the master or secondary unit as a constituent of the access data.

45. The access, monitoring and communication method according to claim 35, wherein time profiles are stored and analyzed in unencrypted or encrypted form by the master or the secondary unit as a constituent of the access data.

46. The access, monitoring and communication method according to claim 35, wherein the access data assigned to the master unit and the access data assigned to the connected secondary unit are stored and analyzed by the master unit in unencrypted or encrypted form for comparison with identification features.

47. The access, monitoring and communication method according to claim 35, wherein only the local access data assigned to the secondary unit for comparison with identification features are stored and analyzed in unencrypted or encrypted form by the secondary unit.

48. The access, monitoring and communication method according to claim 35, wherein the master or secondary unit is connected with the server via the IP network permanently or temporarily for updating the operating software or the access data stored in the memory of the master or secondary unit.

49. The access, monitoring and communication method according to claim 35, wherein in the memory of the master or secondary unit, identification features linked to events and optionally additionally linked with still image data or voice data or still image and voice data are buffered as historical data in unencrypted or encrypted form.

50. The access, monitoring and communication method according to claim 35, wherein unencrypted or encrypted door opening signals are generated by means of a door opening driver and are transmitted wireless or by wireline to a remote door opener switching module.

51. The access, monitoring and communication method according to claim 35, wherein via one of the interfaces of the master or secondary unit at least one application specific module with an interface to the master or secondary unit and at least one further interface to a peripheral system is controlled as output devices from among the following: burglar alarm system, fire alarm system, alarm system, heating, ventilation, air conditioning system, lighting system, and elevator system, and/or a peripheral from among the following: fire alarms, smoke detectors, gas detectors, water detectors, moisture detectors, temperature sensors, motion detectors, contact switches, glassbreak detectors, photoelectric switches as input devices and optical alarm signaling devices, acoustic alarm signaling devices, dialing equipment, switching devices, controls for heating, ventilation, air conditioning, lighting controllers, and elevator controllers.

52. The access, monitoring and communication method according to claim 51, wherein protocols between the interfaces are converted by the application specific module.

53. The access, monitoring and communication method according to claim 51, wherein the application specific module performs a signal conversion from among the following: analog/digital conversion, digital/analog conversion, impedance conversion and interface conversion.

54. The access, monitoring and communication method according to claim 35, wherein data processing by a master processor of the controller of the master or secondary unit is performed by at least one of: encoding, decoding of access, voice and image data for writing to or reading from the memory; transmitting or receiving of data via the IP network or at least one further network or at least one interface; analysis of data which are received by the IP network or the at least one further network or the at least one interface; analysis of received data from peripheral systems or peripherals; control of peripheral systems or peripherals; autonomous control of peripheral systems or peripherals based upon data received from peripheral systems or peripherals; and generation of encrypted or unencrypted door opening signals.

55. The access, monitoring and communication method according to claim 35, wherein an operating-system-independent comprehensive control program is executed in the master processor in the controller of the master unit.

56. The access, monitoring and communication method according to claim 55, wherein a Java language program is used as the operating-system-independent comprehensive program.

57. The access, monitoring and communication method according to claim 35, wherein in the memory of the master or secondary unit, codecs from among voice signals, still image signals and full-motion image signals are stored in unencrypted or encrypted form, updated if necessary, and executed by the master processor.

58. The access, monitoring and communication method according to claim 35, wherein menu-driven operating instructions are stored in unencrypted or encrypted form and executed in the master or the secondary unit.

59. The access, monitoring and communication method according to claim 35, wherein control programs are stored in the master or the secondary unit in unencrypted or encrypted form and are executed for performing at least one of the following: startup, setup and maintenance work.

60. The access, monitoring and communication method according to claim 35, wherein access data are transmitted from the master unit or from the server to the secondary unit and are stored in the memory of the secondary unit in unencrypted or encrypted form.

61. The access, monitoring and communication method according to claim 35, wherein a control program for controlling a selective data transfer of the locally required access data to the respective secondary unit is stored in unencrypted or encrypted form in the memory of the master unit and is executed.

62. The access, monitoring and communication method according to claim 35, wherein a control program for retrieval and intrinsic storage of the locally required access data from the memory of the master unit is stored in unencrypted or encrypted form in the memory of the secondary unit and is executed.

63. The access, monitoring and communication method according to claim 35, wherein a control program for automatic translation of a control program written in a standard language into an abstracted, but functionally equivalent, control program of the respective secondary unit and for transmission to the secondary unit is stored in the memory of the master unit or server in unencrypted or encrypted form and is executed.

64. The access, monitoring and communication method according to claim 35, wherein in the master unit or the server a control program for conversion of a database with standardized data records from the master unit or server into a database with compressed data records of the respective secondary unit and for transmission to the respective secondary unit is stored in unencrypted or encrypted form and is executed.

65. The access, monitoring and communication method according to claim 35, wherein a conversion program for converting standardized data records of access data into compressed data records with compressed field contents from the access data which were prepared from the master unit or from the server and transmitted to the secondary units data is stored in unencrypted or encrypted form in the memory of the secondary unit and is executed.

66. The access, monitoring and communication method according to claim 35, wherein a web server is stored in unencrypted or encrypted form in the master or secondary unit and is executed.

67. The access, monitoring and communication method according to claim 35, wherein a web browser is executed in the master or secondary unit or server.

68. The access, monitoring and communication method according to claim 35, wherein by means of the web browser the overall hierarchy of the device or individual levels or components can be optionally represented using at least one of the following: master unit, secondary unit, peripherals, and peripheral system.
